(19) United States
(12) Patent Application Publication
(10) Pub. No.: US 2022/0254525 A1
(43) Pub. Date: Aug. 11, 2022

(54) USE OF ENDOTHERMIC MATERIALS IN ICE CONDENSER CONTAINMENTS

(71) Applicant: Westinghouse Electric Company LLC, Cranberry Township, PA (US)

(72) Inventor: Cory A. STANSBURY, Gorham, ME (US)

(73) Assignee: Westinghouse Electric Company LLC, Cranberry Township, PA (US)

(21) Appl. No.: 17/597,454

(22) PCT Filed: Jul. 7, 2020
(86) PCT No.: PCT/US2020/041024

§ 371 Date: Jan. 6, 2022

Related U.S. Application Data
(60) Provisional application No. 62/871,898, filed on Jul. 9, 2019.

(51) Int. Cl. G21C 9/012

(52) U.S. Cl. CPC G21C 9/012

(57) ABSTRACT

An energy absorber apparatus is described that includes a plurality of assemblies, each of which contains a plurality of preferably cylindrical tubes, with each tube containing an endothermic material, such as ammonium carbamate. The assemblies are supported in a plurality of elongate baskets positioned in vaults that may surround the periphery of a nuclear reactor containment structure. The energy absorber apparatus absorbs excess energy released in the event of a design basis accident.

### CROSS REFERENCE TO RELATED APPLICATION

This non-provisional application claims the benefit under 35 U.S.C. § 119(e) of U.S. Provisional Patent Application Ser. No. 62/871,898, entitled USE OF ENDOTHERMIC MATERIALS IN ICE CONDENSER CONTAINMENTS, filed Jul. 9, 2019, the disclosure of which is incorporated by reference herein in its entirety.

### BACKGROUND

The present application relates to safety features in nuclear reactors, and more particularly to endothermic material for energy containment in the event of an accident.

Nuclear power is an established form of much-needed clean energy; provided there are no uncontained accidents that would allow the escape of radioactive materials. To avoid such accidents, the nuclear power industry has devoted considerable effort to systems and methods to enhance safety under a variety of possible accident scenarios. One example is the development of ice condenser containments in 1965 that allow ice to absorb the substantial energy that would be released during a loss of coolant accident (LOCA) or a steam line break (SLB). Employment of the ice condenser absorber ultimately permitted a smaller, thinner containment with a lower pressure rating (10-15 psig vs. ˜50-60 psig). Simulations at the time showed an acceleration of typical behavior following a break in the piping with an achievement in containment conditions, which had previous to that time taken about two hours in a dry containment, being reduced to about 5 minutes using ice condensers.

Referring to FIGS. 1-4, reactors with various containment designs are disclosed. FIG. 1 illustrates an exemplary existing reactor that includes a containment structure 10 having an outer peripheral wall 12 and an inner wall 14 and a hatch door 44 for access to the interior. A reactor 16 is housed within the inner wall 14. The reactor is surrounded by a reactor cavity 64 and a refueling cavity 22, filled with coolant, typically water, and covered with removable slabs 28. In various aspects, a containment structure, as illustrated in FIG. 2, includes dividers 26 that separate the steam generators 20 and reactor 16, as high-energy systems, from the rest of the containment; i.e. an upper and lower compartment. Further, A coolant pump 36 pumps hot water from an area above the nuclear fuel located in reactor 16 to a steam generator 20. Upper and lower spray systems 40 and 42, respectively, provide an active means to lower the pressure in a containment structure 10 by removing steam from the air within the a wall 14.

In various aspects, piping 38, penetrates the reactor cavity 64 and connects the reactor 16 to steam generators 20, which function as heat exchangers.

Ice basket assemblies 56 are housed in ice vaults 18. The ice vaults 18 are located in a peripheral annulus within inner wall 14 located around a major portion of the containment structure 10. The lower portion of the vault, as shown in FIG. 2, includes a recirculation sump 30, an accumulator 32, and a pipe annulus 34. The ice vaults 18 separate upper and lower compartments, with all pressure-holding equipment located in the lower compartment. Should a break in the primary pressure boundary (e.g., the reactor vessel, steam generators, coolant pumps and associated piping, which are under about 2250 psi absolute) or secondary pressure boundary (e.g., steam piping, feed water piping and other components under about 1250 or less psi absolute) occur, all steam would be routed through the ice, thus removing a large portion of the energy within the structure.

Within the ice condenser system, there are a number of “doors” through which the steam must pass on its journey between the lower and upper compartments. Lower insulated inlet doors 50 positioned below the ice keep the hot air of the lower compartment from reaching the ice condenser. Insulated intermediate insulated deck doors 52, located directly above the ice, are trapezoid-shaped spring-loaded panels which keep the atmosphere in the ice vaults 18 from exchanging with the upper compartment, thus reducing sublimation and once again reducing heat load. The intermediate deck doors 52 are frequently a cause of problems associated with ice condensers such as, for example, added costs (e.g. maintenance/personnel cost). Top deck doors 54 are typically made of reinforced canvas and merely serve to add an insulating air layer between the intermediate deck doors 52 and the upper compartment of the containment structure 10. Notably, the air in this region is only ˜2° F. warmer than the ice bay (which, itself, is 27° F.±5).

The ice basket assemblies 56 contain ˜2.6M pounds of ice stored in ice baskets 60. These baskets are typically 48 feet tall and 12 inches in diameter. As shown in FIGS. 3 and 4, the baskets 60 are housed in twenty-four ice vaults 18, with each vault holding eighty-one baskets 60, separated by support and alignment grids 62, for a total of 1944 baskets in a containment structure 10. The baskets 60 include four, 12-foot sections. The upper plenum 46 of the ice condenser system, shown in FIG. 5, extends along the space above the ice basket assemblies 56 and provides access to the baskets 60. The upper plenum 46 includes a crane 48 for lifting the baskets, air handling units 58, and duct work (not shown), walkways, and other features known to those in the nuclear power industry.

The maintenance of the 192 intermediate deck doors 52 in a containment structure 10 must be checked at least once per week for proper operation. During reactor outages, the baskets 60 are also inspected and the ice weighed using a statistical process based on weighing of a subset of baskets in each quadrant. Certain nuclear plants have experienced ice melting together into blocks, reducing the surface area of the ice, and thus anticipated performance. Depending on location, some ice baskets 60 are relatively easy to access and inspect. However, the remainder require some disassembly to access.

The ice itself is flaked in shape, borated so that it can double as a neutron absorber once melted, and produced by industrial ice machines. Large refrigeration equipment is required to keep the space cold, using a combination of ducted air on the walls and chilled water/glycol which is run via a tubing 11 extending through a plate in the floor of the structure 10. Each quadrant in a containment structure is built with a plate/glycol tubing assembly installed on top of porous, insulating concrete and then poured over during construction. This represents a lot of additional equipment to maintain and power.

While nuclear facilities using ice condenser systems have proven to be economical, operators have a number of challenges and long-term maintenance costs due to the additional equipment and cooling requirements which don't exist with “traditional” plants.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, abstract and drawings as a whole.

The concept would replace the ice with sealed or vented, endothermic absorbers, which would permit the elimination of numerous troublesome component and equipment needs. The concept can also be implemented in new nuclear reactor designs.

An apparatus for absorbing energy in a nuclear reactor containment structure, for example, in the event of a loss of coolant or steam line break, includes at least one assembly comprising a plurality of elongate tubes, and an endothermic material, such as ammonium carbamate, housed in and occupying a majority of each tube.

The amount of endothermic material is preferably sufficient to remove energy from, and maintain the structural integrity of, a containment structure in an initial energy release arising from an accident and, together with other nuclear safety systems, for subsequent heat removal during fuel decay for a subsequent period of time following blowdown.

The apparatus may further include a plurality of support structures for holding the tubes. The tubes may be stacked one assembly on top of another.

The apparatus may also include a plurality of elongate baskets, wherein each basket holds one assembly. Further, each basket may include grids for aligning the tubes within the assembly axially relative to the basket.

The tubes and assemblies may be shorter in height than the baskets. There may be a plurality of tubes stacked one assembly on top of another in each basket. In certain aspects, the height of the tubes and assemblies may be substantially the same height as the baskets. Each tube may further include free space not occupied by the endothermic material to accommodate gases produced in use by chemical reactions of the endothermic material.

In various aspects, the tubes are sealed. In various aspects, the tubes are vented and include a pressure release valve fluidly connected to a portion of the tubes, such as a tube cover. In various aspects, when the endothermic material is ammonium carbamate and the tubes are vented, the ammonium carbamate reaction products released in venting act as a buffer in sump water in the containment structure.

The endothermic material may be in the form of a slurry, which is made from a liquid mixed with the endothermic material. The liquid may be a solvent. In various aspects, the liquid may be selected from the group consisting of water, an alcohol, ethylene glycol and propylene glycol, and other solvents.

In various aspects, each tube is cylindrical. In various alternative aspects, each tube is non-cylindrical. In various aspects, each tube has a wall having a thickness ranging from less than 3/100^{th} inch to 1/100^{th} of an inch. Each tube may be linear or may be non-linear.

### BRIEF DESCRIPTION OF THE DRAWINGS

Various features of the embodiments described herein are set forth with particularity in the appended claims. The various embodiments, however, both as to organization and methods of operation, together with advantages thereof, may be understood in accordance with the following description taken in conjunction with the accompanying drawings as follows:

FIG. 1 is a cutaway image of a prior art containment structure built in Finland and having horizontally oriented generators, showing ice condensers surrounding a reactor.

FIG. 2 is a cutaway image of a prior art pressurized water reactor containment structure built in several locations in the United States, showing the arrangement of reactor, vertically oriented steam generators, ice condensers, and related components of a conventional pressure water reactor.

FIG. 3 shows representative ice baskets that would be housed in a condenser.

FIG. 4 is a top section view of an exemplary containment structure showing twenty-four vaults and equipment compartments.

FIG. 5 illustrates the upper plenum of an ice condenser showing the intermediate and upper deck doors and ice baskets.

FIG. 6 is an illustration of an exemplary nuclear fuel assembly including cylindrical bundle of tubes that can be filled with endothermic material.

FIG. 7 is an illustration of an exemplary nuclear fuel assembly including cylindrical bundle of tubes that can be filled with endothermic material showing an optional perforated housing.

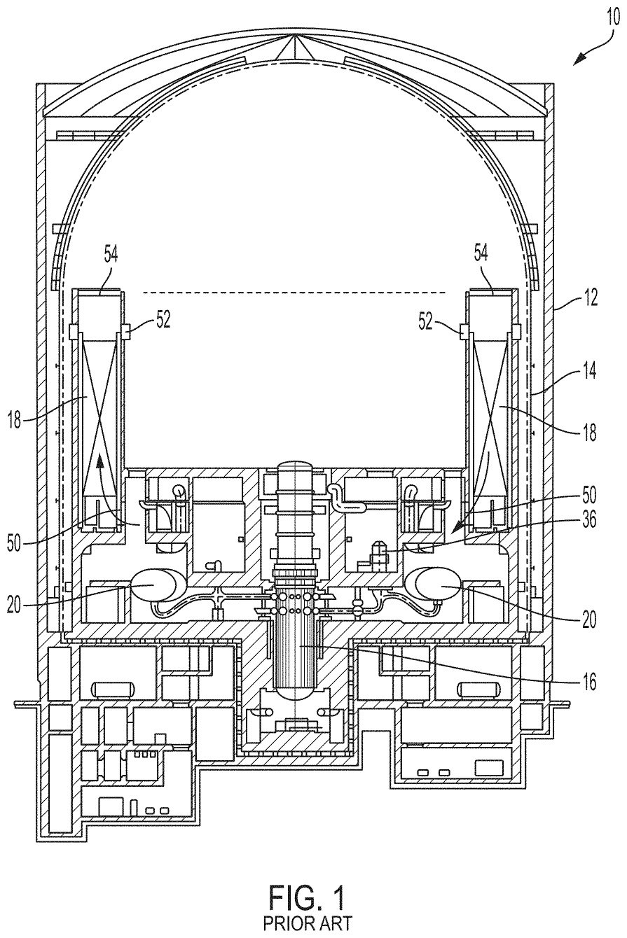

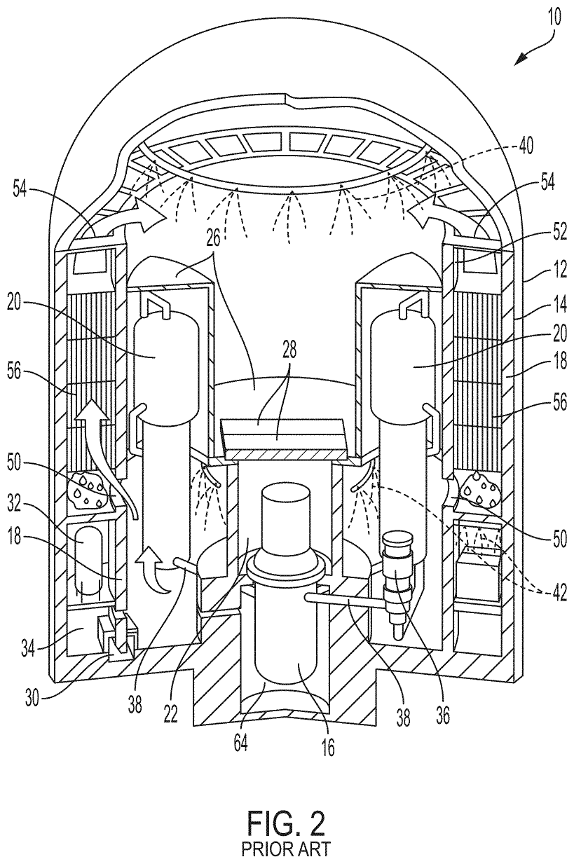

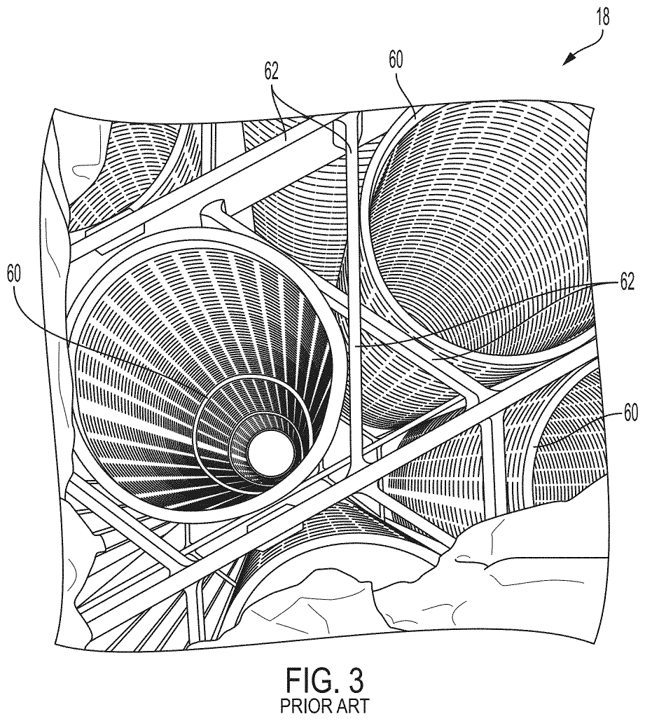

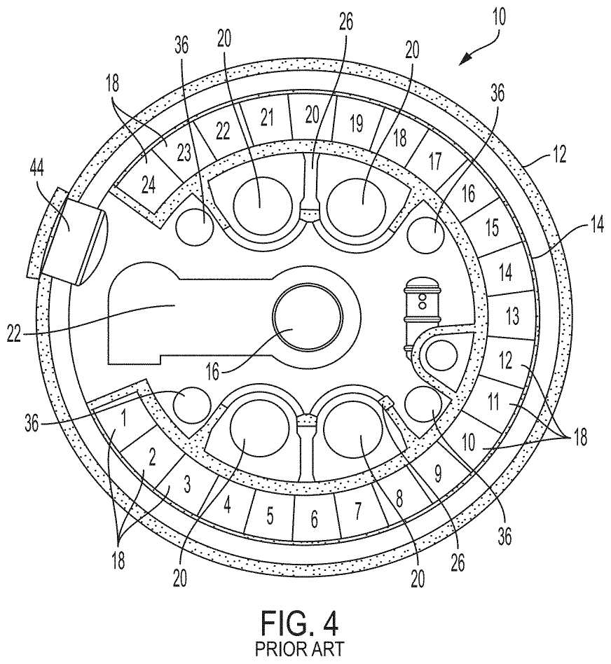

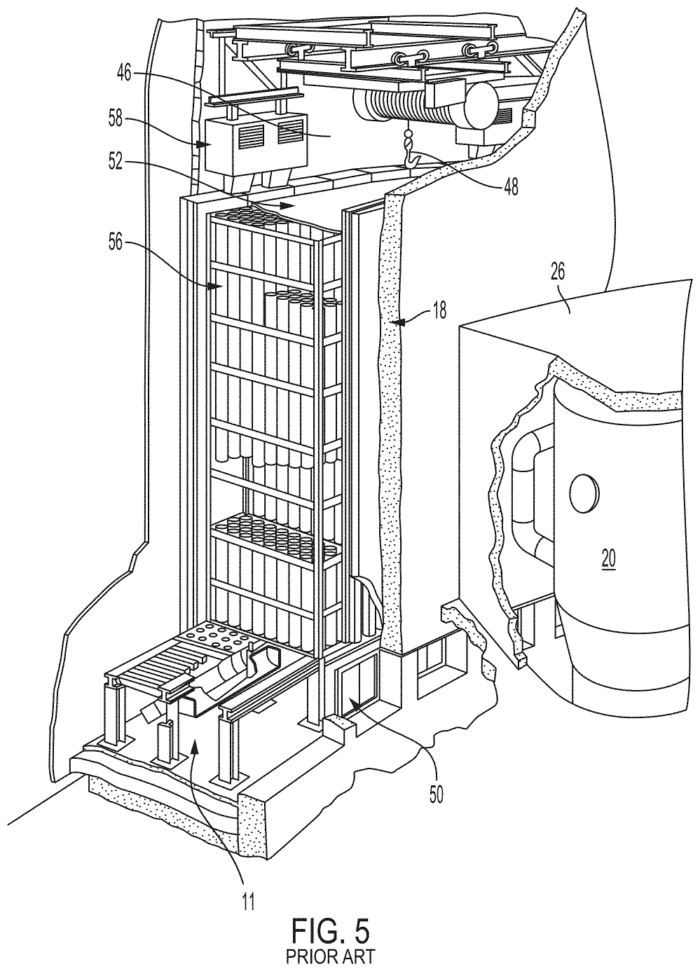

Corresponding reference characters indicate corresponding parts throughout the several views. The exemplifications set out herein illustrate various embodiments of the invention, in one form, and such exemplifications are not to be construed as limiting the scope of the invention in any manner.

### DESCRIPTION

Before explaining various aspects of the present disclosure in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or“approximately” means within 50%, 20%, 15%, 10%, 9%, 8%, 7%, 6%, 5%, 4%, 3%, 2%, 1%, 0.5%, or 0.05% of a given value or range.

Any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In order to address the problems with using ice as an energy absorber in the event of a design basis accident, such as a loss of coolant accident or steam line break accidents, a more economical and easier to maintain means of absorbing energy under such accident conditions is described herein. Design basis accident, as used herein is defined by the U.S. Nuclear Regulatory Commission as, “A postulated accident that a nuclear facility must be designed and built to withstand without loss to the systems, structures, and components necessary to ensure public health and safety.”

The proposed energy absorber comprises an assembly 100 of preferably cylindrical tubes 70, each of which contains an endothermic material. The assembly 100 may include tube support structures 76 as an exemplary means to fasten the tubes 70 together. The assembly of tubes 70 may fit in the existing baskets 60. In many instances, especially where existing ice systems are being replaced by the endothermic energy absorbing assembly, the same baskets 60 may be used. Alternatively, the baskets 60 may be replaced by tube bundles designed such that they would fasten to existing alignment grid structures 62. Any suitable support structure for holding the tubes 70 in position would suffice. The energy absorber assembly 100 would entirely replace the function of the existing ice in absorbing energy during a large energy release. The intermediate deck doors 52, and all refrigeration, chilling, and air handling equipment would be removed, simplifying the structure.

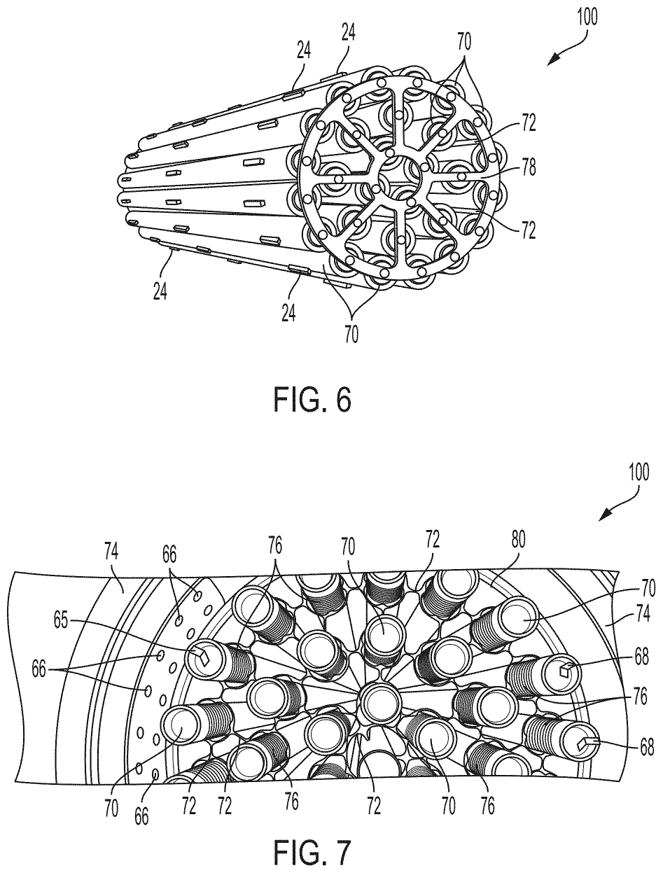

Referring to FIGS. 6 and 7, exemplary assemblies 100 are shown. Referring to FIG. 6, the tubes 70 are grouped along the spokes 78 of a support structure and may include stabilizing grids 72. In FIG. 7, each tube 70 is held in a support structure 76, and multiple support structures 76 are joined by stabilizing grids 72 of a different design, connected to a peripheral holder 80. In certain aspects, the tubes may be placed in existing baskets 60. In certain aspects, the existing baskets may be replaced with a perforated housing 74, and support structures 76 and tubes 70 may be contained in a housing 74 having perforations 66. Tubes 70 may be sealed or may be vented with any suitable pressure release valve 68 (only a few are shown in black box form for illustrative purposes. Those skilled in the art will recognize that all or some or none of the tubes may be vented with any suitable means for venting and that the vents or release valves may be placed in other locations on the tubes 70.). In certain examples, one or more of the tubes 70 include burst desks.

Cylindrical tubes 70 are preferred because they are manufactured in any material desired, maintain their strength under pressure (both externally and internally), and are well-understood in heat transfer applications. Those skilled in the art will appreciate, however, that other configurations for the tubes 70 may be used, with appropriate adjustments to materials and dimensions to accommodate the anticipated pressure and temperature exposure during use in a nuclear reactor, particularly under accident scenarios. Similarly, housings 74 may be cylindrical or may have any other cross-sectional configuration that will accommodate the number of tubes 70 in an energy absorber assembly 100 desired in a containment structure 10. The tubes 70 may be made from carbon steels, stainless steels, or other nuclear-qualified materials with sufficient heat transfer and corrosion resistance to meet design requirements. The tubes 70 may, in various aspects, include surface treatments, fins 24, and non-linear designs that would enhance condensation performance.

The bundles of the tubes 70 may be axially-loaded into the baskets 60 from the top of the baskets. The tubes 70 would be shorter in height than the height of the baskets 60. In various aspects, the tubes 70 may be dimensioned to allow a plurality of tubes 70 to be stacked one on top of another in a basket 60. Alternatively, the tubes 70 may be substantially the same height as the baskets 60, allowing some room to sit within and not extend above the basket opening so that spokes 78 can be attached over the top, or on the end of the assembly 100, as shown in FIG. 6. In certain aspects, the tubes 70 may extend beyond the opening of the baskets, as shown in FIG. 7. The tubes 70 are in various aspects designed to structurally tolerate stacking and other loads which would be required to avoid damage to the tubes or the alignment grids 62.

An endothermic material would be located inside of the tubes 70. Because chemical reaction rates are affected by pressure, consideration in manufacturing would be given to factors such as the initial loading volume, free volume, and the pressure tolerances of the tube material. Initial calculations suggest that the amount of endothermic material needed for total energy removal, relative to ice, in a containment structure 10 is likely to be less than that needed to match the initial blowdown transient energy absorption requirements.

Anticipated pressures within the tubes 70 during operation are not significant. The tube wall thickness should be thick enough to withstand the pressure from chemical reactions within the tube but thin enough to allow heat to pass through the tube. At this time, it cannot be suggested exactly how high the pressures would reach, but it is believed likely to be in the 10 s to low 100 s of psi. As such, thin-wall tubing (for example, less than 3/100^{th} of inch to about 1/100^{th} of an inch in thickness may be useful. In at least one example, the thin-wall tubing comprises a thickness selected from a range of 2/100^{th} of inch to about 5/1000^{th} of an inch, for example, or a range of 5/100^{th} of inch to about 1/1000^{th} of an inch, for example. Thin walled tubes 70 would be beneficial because it allows for increasing the volume of endothermic materials in the tube, decreases the structural weight, tube cost, and temperature loss through the wall. Temperature is an important factor in moving heat into the endothermic materials and driving the reaction.

In existing nuclear power plants, an ice condenser plant will melt a large volume of water during a casualty. This borated melt water will become part of the sump volume. The energy absorber assembly 100 described herein will not release water. Therefore, the volume of the refueling water storage tank (a large tank (not shown) typically located outside of the containment structure that is designed to supply water during the early part of an accident) and appropriate changes to the timing of switching the injection pumps from the refueling water storage tank to the sump 30 as a water source may, in various aspects, be changed. In various aspects, one or both of a larger or an additional refueling water storage tank and a source of a chemical buffer to counter the acidity of the boron absorbers may be provided. Currently, sodium tetraborate is the boron form used in the ice and is intrinsically buffered. However, refueling water storage tank water does not use this boron form, thus some means of buffer must be provided

In various aspects, the endothermic material used in the tubes 70 includes compounds capable of undergoing a thermal decomposition. In various aspects, the endothermic material used in the tubes 70 is selected from chemicals that are relatively inexpensive, capable of removing copious quantities of energy in the event of an accident, that remain stable at operational containment temperatures, are reasonably safe and compatible with nuclear materials (both as reactants and products), and that operate at the desired temperatures needed to allow operation of the energy absorbing function.

An exemplary endothermic material is ammonium carbamate (NH₄(H₂NCO₂) (AC). AC, through an endothermic chemical reaction, absorbs energy over a range of temperatures (approximately 10-60° C., related to pressure) useful to condensation in an ice condenser's vaults. Its volumetric energy removal is approximately 2760 MJ/m³, which is approximately 9 times that of ice. Its products of reaction are carbon dioxide (CO₂) and ammonia (NH₃), neither of which are detrimental and both of which are already present within the primary side of the reactor 16 and the containment structure 10, satisfying the safety and compatibility requirements for the material.

As AC is heated, it forms CO₂ and NH₃ gases in equilibrium with the solid as a function of the temperature with the pressure. As steam is released into the containment, it heats through the AC holders and begins the decomposition of the AC inside the holders while condensing the steam. In unvented embodiments of the tubes, the CO₂ and NH₃ gases remain in the tube. The pressure increase is not sufficient to cause any leakage in the tubes.

At this time, ammonium carbamate is the preferred endothermic material. It appears to have adequate performance, is relatively inexpensive, has benign reaction products, can be made stable at desired temperature ranges of 80-120° F., and is easily sourced. Other suitable endothermic materials that have the desired qualities, the most important of which are its energy absorbing capacity, stability during normal operating conditions, and safety, may be used.

Loading the tubes with the endothermic material may be eased by the use of slurries. In various aspects, a slurry of the ammonium carbamate would be mixed with a liquid. Candidates for the liquid may include propylene glycol or ethylene glycol, alcohols, and water. The slurry would be used to fill a majority, if not all, of the space in each tube 70. Some free space may remain after filling to accommodate gases produced in use. The pressure within the filled or partially filled tube 70 may be adjusted by back filling the tube with a non-reactive gas, such as Argon, or, conversely, pulling a vacuum. Thereafter, the tube 70 would be covered. In various aspects, the covered tube 70 is sealed against any leaks. In various aspects, the covered tube 70 may be vented, for example by means of a pressure relief valve that may be connected in a suitable known manner to the tube cover.

The surface area of the tube 70 rather than the chemical kinematics of the endothermic material appears to be the driving factor in condensing performance. The coupled relationship between the tube and endothermic chemistry must be understood to perform performance estimations. Tube diameter, number, wall thickness, and assumed free volume percentage will ultimately dictate the volume of chemical housed. However, chemical volume, tube diameter, amount reacted, and temperature will influence the chemical kinematics and thus, the energy removed per tube area. These parameters vary along the length of tube and with time during a transient event. These complex interactions can be modeled, along with two-phase flow calculations in a nodal methodology, to estimate the condenser performance achieved by a given configuration. The nuclear safety code GOTHIC may be useful for these calculations. Work to date using GOTHIC indicates that the amount of endothermic material may be 3-4 times that required to simply match the amount of energy ice is capable of removing. An increase of total energy removed of 300-400% may be realized. These calculations showed that the ammonium carbamate chemistry is of sufficient performance and reinforced the multiple benefits of a slurry for ease of loading.

In various aspects, the energy absorber assemblies described herein, compared to the existing ice condenser design replace the ice with an endothermic chemical energy absorber, such as ammonium carbamate, and/or directly replace the ice or ice and ice baskets 60 with a cylindrical assembly of thin-walled tubes 70 containing the endothermic material energy absorber (for example, ranging from 0.25-0.625″ in inner diameter with triangular pitch of 1.25 to 1.5×). In various aspects, the energy absorber assemblies described herein use sealed tubes 70 with some free volume to tune chemical performance and greatly simplify concerns related to chemical products interfering with previously-analyzed safety mechanisms/systems. In various aspects, the energy absorber assemblies described herein use a chemical slurry as a means to increase performance and ease tube loading. In various aspects, the energy absorber assemblies described herein allow elimination of refrigeration and ice-making systems within the power plant, and/or allow elimination of intermediate deck doors.

In various aspects, the energy absorber assemblies described herein improve energy absorption relative to original ice, which adds a safety margin to the plant's ability to withstand beyond design basis conditions. In certain aspects, sump water not generated through ice melting is replaced by using a change of switchover time between the refueling water storage tank and sump for safety pumps, additional tech spec volume requirement in the refueling water storage tank (which may dictate an additional tank), and/or possible addition of a means to deliver sodium tetraborate and/or a suitable buffer/boron form to maintain desirable sump chemistry.

Employment of the energy absorber assemblies described herein results in one or more benefits to existing ice condenser power plants such as, for example, eliminating additional cavity refrigeration need, and thus systems; eliminating glycol systems, which cool the ice vault floor and have dedicated chillers; eliminating sublimation and ice weighing/refilling necessity during outages (significant outage activity); eliminating intermediate deck doors; eliminating at-power, weekly containment incursions to test intermediate deck doors (lower dose); minimizing outage work cost, duration, and personnel need; eliminating ice fusing concerns at some plants; and improving safety margin for beyond design basis events.

Various aspects of the subject matter described herein are set out in the following examples.

Example 1—An apparatus for absorbing energy in a nuclear reactor containment structure comprising at least one assembly comprising elongate tubes and an endothermic material housed in and occupying a majority of each of the elongate tubes, wherein the endothermic material is configured to undergo an endothermic reaction in the elongate tubes.

Example 2—The apparatus recited in Example 1, further comprising support structures for holding the elongate tubes.

Example 3—The apparatus recited in Examples 1 or 2, wherein the elongate tubes are stacked one assembly on top of another.

Example 4—The apparatus recited in any one of Examples 1-3, wherein each of the elongate tubes further comprises free space not occupied by the endothermic material to accommodate gases produced in use by chemical reactions of the endothermic material.

Example 5—The apparatus recited in any one of Examples 1-4, wherein the elongate tubes are sealed.

Example 6—The apparatus recited in any one of Examples 1-4, wherein the elongate tubes are vented and further comprise a pressure release valve.

Example 7—The apparatus recited in any one of Examples 1-6, wherein the endothermic material is ammonium carbamate.

Example 8—The apparatus recited in Example 7, wherein the elongate tubes are vented and ammonium carbamate reaction products are released in a venting act as a buffer in sump water in the nuclear reactor containment structure.

Example 9—The apparatus recited in any one of Examples 1-8, wherein the endothermic material is in the form of a slurry.

Example 10—The apparatus recited in Example 9, wherein the slurry comprises a liquid mixed with ammonium carbamate.

Example 11—The apparatus recited in Example 10, wherein the liquid is a solvent.

Example 12—The apparatus recited in Examples 10 or 11, wherein the liquid is

selected from the group consisting of water, an alcohol, ethylene glycol, and propylene glycol.

Example 13—The apparatus recited in any one of Examples 1-12, wherein at least one of the elongate tubes is cylindrical.

Example 14—The apparatus recited in any one of Examples 1-13, wherein at least one of the elongate tubes is non-cylindrical.

Example 15—The apparatus recited in any one of Examples 1-14, wherein each of the elongate tubes has a wall having a thickness ranging from less than 3/100^{th} of an inch to 1/100^{th} of an inch.

Example 16—The apparatus recited in any one of Examples 1-15, wherein the amount of endothermic material is sufficient to remove energy from a containment structure in an initial energy release arising from an accident and for subsequent heat removal during fuel decay.

Example 17—The apparatus recited in any one of Examples 1-16, wherein the elongate tubes have fins.

Example 18—The apparatus recited in any one of Examples 1-17, wherein the elongate tubes comprise a non-linear configuration to enhance condensation performance.

Example 19—An apparatus for absorbing energy in a nuclear reactor containment structure comprising at least one assembly comprising elongate tubes and a compound configured to undergo a thermal decomposition in the elongate tubes, wherein the elongate tubes are at least partially occupied by the compound.

Example 20—The apparatus recited in Example 19, further comprising support structures for holding the elongate tubes.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification.” and the like means that a particular feature, structure, or characteristic described in connection with the aspect is included in at least one aspect. Thus, appearances of the phrases “in one aspect,” “in an aspect.” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. An apparatus for absorbing energy in a nuclear reactor containment structure comprising:
at least one assembly comprising elongate tubes; and
an endothermic material housed in and occupying a majority of each of the elongate tubes, wherein the endothermic material is configured to undergo a chemical endothermic reaction in the elongate tubes.

2. The apparatus recited in claim 1, further comprising support structures for holding the elongate tubes.

3. The apparatus recited in claim 2, wherein the elongate tubes are stacked one assembly on top of another.

4. The apparatus recited in claim 1, wherein each of the elongate tubes further comprises free space not occupied by the endothermic material to accommodate gases produced in use by chemical reactions of the endothermic material.

5. The apparatus recited in claim 1, wherein the elongate tubes are sealed.

6. The apparatus recited in claim 1, wherein the elongate tubes are vented and further comprise a pressure release valve.

7. The apparatus recited in claim 1, wherein the endothermic material is ammonium carbamate.

8. The apparatus recited in claim 7, wherein the elongate tubes are vented and ammonium carbamate reaction products are released in a venting act as a buffer in sump water in the nuclear reactor containment structure.

9. The apparatus recited in claim 1, wherein the endothermic material is in the form of a slurry.

10. The apparatus recited in claim 9, wherein the slurry comprises a liquid mixed with ammonium carbamate.

11. The apparatus recited in claim 10, wherein the liquid is a solvent.

12. The apparatus recited in claim 10, wherein the liquid is selected from the group consisting of water, an alcohol, ethylene glycol, and propylene glycol.

13. The apparatus recited in claim 1, wherein at least one of the elongate tubes is cylindrical.

14. The apparatus recited in claim 1, wherein at least one of the elongate tubes is non-cylindrical.

15. The apparatus recited in claim 1, wherein each of the elongate tubes has a wall having a thickness ranging from less than 3/100^{th} of an inch to 1/100^{th} of an inch.

16. The apparatus recited in claim 1, wherein the amount of endothermic material is sufficient to remove energy from a containment structure in an initial energy release arising from an accident and for subsequent heat removal during fuel decay.

17. The apparatus recited in claim 1, wherein the elongate tubes have fins.

18. The apparatus recited in claim 1, wherein the elongate tubes comprise a non-linear configuration to enhance condensation performance.

19. An apparatus for absorbing energy in a nuclear reactor containment structure comprising:
at least one assembly comprising elongate tubes; and
a compound configured to undergo a thermal, chemical decomposition in the elongate tubes, wherein the elongate tubes are at least partially occupied by the compound.

20. The apparatus recited in claim 19, further comprising support structures for holding the elongate tubes.
